(19) United States
(12) Patent Application Publication
(10) Pub. No.: US 2020/0135001 A1
(43) Pub. Date: Apr. 30, 2020

(54) SAFETY CARD BASED ON WIRELESS MESH NETWORK

(71) Applicant: HONEYWELL INTERNATIONAL INC., Morris Plains, NJ (US)

(72) Inventors: Feng LIANG, Morris Plains, NJ (US); Kenny GAO, Morris Plains, NJ (US); Jian GAO, Morris Plains, NJ (US); Qijun WANG, Morris Plains, NJ (US); Yu Lin LI, Morris Plains, NJ (US)

(21) Appl. No.: 16/494,134

(22) PCT Filed: Mar. 15, 2017
(86) PCT No.: PCT/CN2017/076712

§ 371 Date: Sep. 13, 2019

(51) Int. Cl. G08B 21/14; G08B 21/16; G08B 25/10; H04W 4/90; H04B 5/00; H04W 4/80

(52) U.S. Cl. CPC G08B 21/14; G08B 21/16; H04W 4/80; H04W 4/90; H04B 5/0031; G08B 25/10

(57) ABSTRACT

Systems and methods for gas detection are provided. A safety card may comprise a gas detector, wherein the gas detector comprises: a sensing element configured to sense gas; and a wireless module coupled to the sensing element, wherein the wireless module is configured for an 802.15.4 wireless mesh network; wherein the safety card is configured to communicate over the 802.15.4 wireless mesh network with a plurality of other safety cards and a smart phone; and a near field communication identification module, wherein the near field communication identification module is configured to communicate with a near field communication reader and provide an identification of the safety card to the near field communication reader.

### CROSS-REFERENCE TO RELATED APPLICATIONS

Not applicable.

### STATEMENT REGARDING FEDERALLY SPONSORED RESEARCH OR DEVELOPMENT

Not applicable.

### REFERENCE TO A MICROFICHE APPENDIX

Not applicable.

### BACKGROUND

Gas detection systems may be utilized in secured areas to protect people and assets from toxic gas leaks. Such systems may utilize gas sensors distributed throughout the secured areas. The gas sensors may periodically measure a gas level proximate to the gas sensors, and relay this information to a central monitoring system.

### SUMMARY

In an embodiment, a safety card may comprise a gas detector, wherein the gas detector comprises: a sensing element configured to sense gas; and a wireless module coupled to the sensing element, wherein the wireless module is configured for an 802.15.4 wireless mesh network; wherein the safety card is configured to communicate over the 802.15.4 wireless mesh network with a plurality of other safety cards and a smart phone; and a near field communication identification module, wherein the near field communication identification module is configured to communicate with a near field communication reader and provide an identification of the safety card to the near field communication reader, wherein a height of the safety card is about 40 mm to about 60 mm; wherein a width of the safety card is about 60 mm to about 90 mm; wherein a thickness of the safety card is less than about 4 mm; wherein the safety card is configured for access to a secured area.

In an embodiment, a method for gas detection may comprise detecting a gas with a safety card, wherein the safety card comprises: a sensing element configured to sense gas; and a wireless module, wherein the wireless module is configured for an 802.15.4 wireless mesh network; wherein the safety card is configured to communicate over the 802.15.4 wireless mesh network with a plurality of safety cards; wherein a height of the safety card is about 40 mm to about 60 mm; wherein a width of the safety card is about 60 mm to about 90 mm; wherein a thickness of the safety card is less than about 4 mm; sensing that a concentration of the gas is above or below a predetermined threshold; activating an alarm based on the concentration of the gas; transmitting the alarm to the plurality of safety cards via the 802.15.4 wireless mesh network; transmitting a near field communication identification from the safety card to a near field communication reader in response to placing the safety card near the near field communication reader; and granting access to a restricted area in response to the near field communication identification matching an approved near field identification for the restricted area.

In an embodiment, a system for gas detection comprising: a plurality of safety cards, wherein each safety card comprises: a sensing element configured to sense gas; and a wireless module, wherein the wireless module is configured for an 802.15.4 wireless mesh network; wherein the safety card is configured to communicate over the 802.15.4 wireless mesh network; wherein a height of the safety card is about 40 mm to about 60 mm; wherein a width of the safety card is about 60 mm to about 90 mm; wherein a thickness of the safety card is less than about 4 mm; a smart phone; a gateway; a server; and a central station; wherein the plurality of safety cards, the gateway, the server, and the central station are connected to the 802.15.4 wireless mesh network; wherein the plurality of safety cards are configured to access a secured area.

These and other features will be more clearly understood from the following detailed description taken in conjunction with the accompanying drawings and claims.

### BRIEF DESCRIPTION OF THE DRAWINGS

For a more complete understanding of the present disclosure, reference is now made to the following brief description, taken in connection with the accompanying drawings and detailed description, wherein like reference numerals represent like parts.

FIG. 1 is a schematic illustration of a safety card in accordance with embodiments of the disclosure.

FIG. 2 is a schematic illustration of inner components of a safety card in accordance with embodiments of the disclosure.

FIGS. 3 and 4 are schematic illustrations of removing a top cover of a safety card in accordance with embodiments of the disclosure.

FIG. 5 is a schematic illustration of a wireless mesh network for use with safety cards in accordance with embodiments of the disclosure.

### DETAILED DESCRIPTION

It should be understood at the outset that although illustrative implementations of one or more embodiments are illustrated below, the disclosed systems and methods may be implemented using any number of techniques, whether currently known or not yet in existence. The disclosure should in no way be limited to the illustrative implementations, drawings, and techniques illustrated below, but may be modified within the scope of the appended claims along with their full scope of equivalents.

The following brief definition of terms shall apply throughout the application:

The term “comprising” means including but not limited to, and should be interpreted in the manner it is typically used in the patent context;

The phrases “in one embodiment,” “according to one embodiment,” and the like generally mean that the particular feature, structure, or characteristic following the phrase may be included in at least one embodiment of the present invention, and may be included in more than one embodiment of the present invention (importantly, such phrases do not necessarily refer to the same embodiment);

If the specification describes something as “exemplary” or an “example,” it should be understood that refers to a non-exclusive example;

The terms “about” or “approximately” or the like, when used with a number, may mean that specific number, or alternatively, a range in proximity to the specific number, as understood by persons of skill in the art field; and

If the specification states a component or feature “may,” “can,” “could,” “should,” “would,” “preferably,” “possibly,” “typically,” “optionally,” “for example,” “often,” or “might” (or other such language) be included or have a characteristic, that particular component or feature is not required to be included or to have the characteristic. Such component or feature may be optionally included in some embodiments, or it may be excluded.

Embodiments of the disclosure may include a low cost gas detector and access card (e.g., a safety card) that may be utilized for detecting safe gas levels (e.g., oxygen (O₂)) and toxic gas levels (e.g., carbon monoxide (CO), hydrogen sulfide (H₂S)), and controlling access to secured areas (e.g., hazardous environments, restricted areas, etc.). Users/workers may wear the safety card daily at work where there may be potentially hazardous gas conditions. The safety card may be a credit card size solution with gas sensors (e.g., Honeywell Industrial Safety (HIS)) and NFC ID (near field communication identification) information for access control to secured areas. Generally, the gas detector and access card are two separate devices, and some users/workers may not be able to move throughout their work environment without the access card. By placing the gas detector into the access card, it may help to ensure that the users/workers cannot leave the gas detector behind.

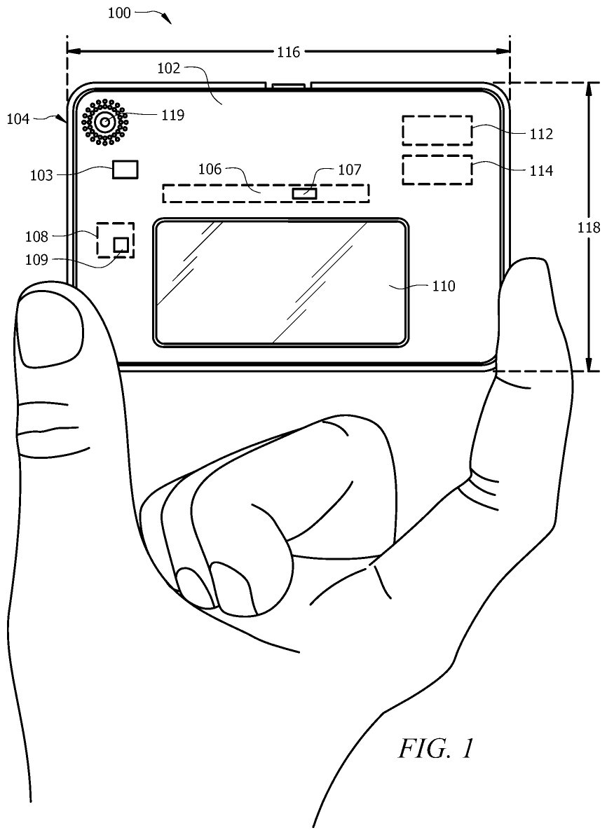

FIG. 1 is a schematic illustration of safety card 100. Safety card 100 may be configured to detect multiple gases simultaneously (e.g., O₂, H₂S, NOₓ, and/or CO). Safety card 100 may include cover 102, bottom cover 104, sensing element 106, wireless module 108, display 110, processor 112, and memory 114. Safety card 100 may include NFC ID information for access control to secured areas. The dimensions of safety card 100 may be similar to those of a credit card. A width 116 of safety card 100 may be about 60 millimeters (“mm”) to about 90 mm. A height 118 of safety card 100 may be about 40 mm to about 60 mm. A thickness of safety card 100 may be less than about 8 mm (e.g., less than about 4 mm).

Top cover 102 may be coupled to bottom cover 104 by any suitable means, such as, for example, press fitting. Top cover 102 may be removable from bottom cover 104 in order to access inner components of safety card 100. Top cover may include speaker 103 for audible messages (e.g., an alarm). Top cover 102 and bottom cover 104 may be made from any suitable material, such as, for example, plastic, metal, or combinations thereof. Top cover 102 may include vent 119, thereby allowing gas to contact sensing element 106.

Sensing element 106, wireless module 108, processor 112, and memory 114 may be disposed between top cover 102 and bottom cover 104. Sensing element 106, wireless module 108, processor 112, and memory 114 may be operatively coupled to one another (e.g., electrically and/or mechanically).

Sensing element 106 may be configured to sense gas proximate to safety card 100. Sensing element 106 may also detect temperature, humidity and/or noise proximate to safety card 100. Sensing element 106 may include a solid electro-chemical sensor (SECS), which may be a miniaturized and printable sensor. Sensing element 106 may comprise an electrochemical cell or another gas sensing technology such as a reactive material 107. If the reactive material 107 is exposed to a threshold amount of a target gas, reactive material 107 may change color, absorption, reflection, etc., which may be detected by a sensor within the safety card 100. This change may be sufficient to trigger a gas alarm.

Wireless module 108 may allow safety card 100 to communicate data over a wireless network. Wireless module 108 may include a near field communication identification module 109. Wireless module 108 may also be utilized to locate safety card 100, thereby locating a user/worker wearing safety card 100. Safety card 100 may also be configured to access cloud storage and/or cloud services, thereby storing/accessing data relating to gas detection in the cloud. Processor 112 and memory 114 may allow for processing and storage of data relating to gas detection (e.g., air quality (safe/unsafe), time, user location, gas detection history data, emergency information, alarms, gas exposure limits, gas concentration, and/or user identification information). Gas detection history data may include stored data during previous operations of safety card 100: air quality (safe/unsafe), time, user location, emergency information, alarms, gas exposure limits, gas concentration, and/or user identification information. Display 110 may be positioned on top cover 102. Display 110 may provide a user interface for viewing the data relating to gas detection and data relating to operation of safety card 100. Upon sensing gas (e.g., above or below a predetermined threshold for gas concentration) with sensing element 106, safety card 100 may activate an alarm which may be displayed on display 110. Safety card 100 may also activate an audible alarm via speaker 103.

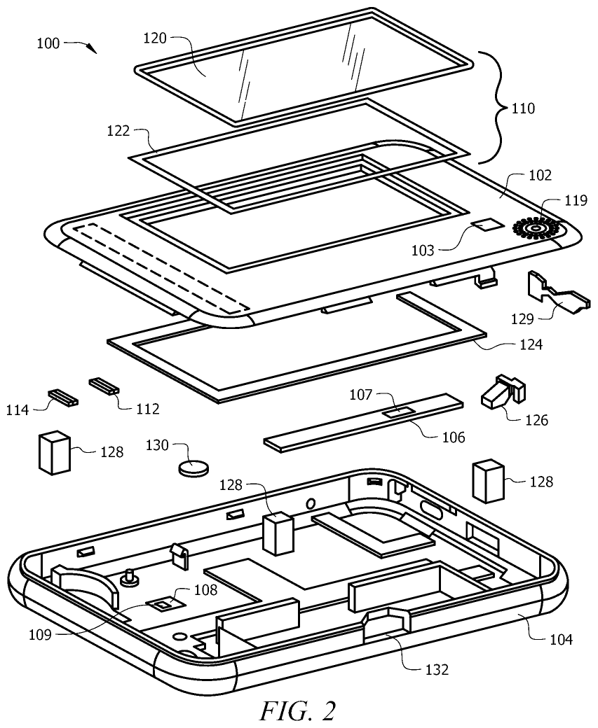

FIG. 2 is a schematic illustration of the inner components of safety card 100. Display 110 may include viewing screen 120 and seal 122. Seal 122 may be positioned between viewing screen 120 and top cover 102. LED (light emitting diode) screen 124 may be positioned between bottom cover 104 and top cover 102. LED lens 126 may be positioned underneath LED screen 124. Sponge pads 128 may be positioned between the inside of bottom cover 104 and LED screen 124, thereby supporting LED screen 124 within safety card 100. Button 129 may be positioned within a corner of top cover 102. Button 129 may be utilized to navigate a user interface (e.g., power safety card 100 on/off, settings/menu of safety card 100, accessing data of safety card 100) shown on display 110. Battery 130 may be positioned within safety card 100, thereby providing power to safety card 100 (e.g., sensing element 106, processor 112, memory 114, LED lens 126).

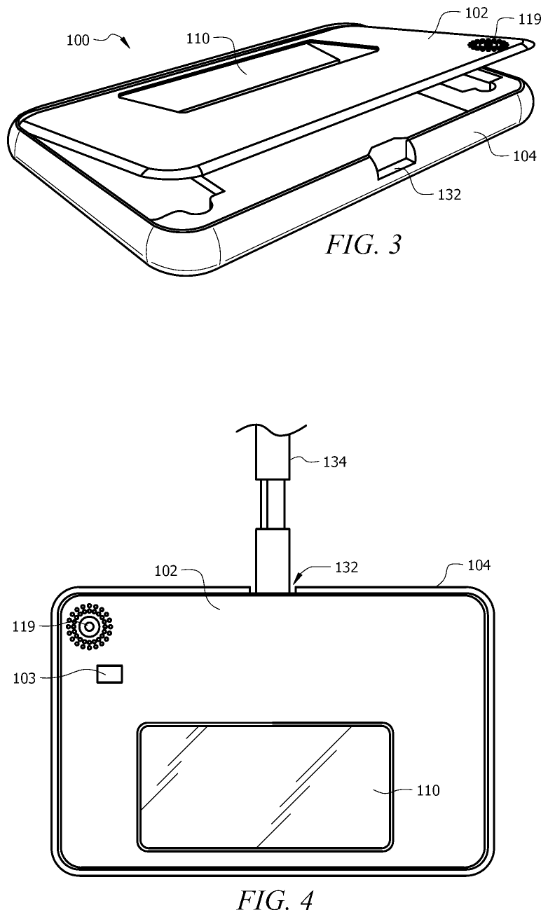

FIGS. 3 and 4 are schematic illustrations of removing top cover 102 of safety card 100. As shown on FIG. 3, bottom cover 104 may include an indentation 132. Prying device 134 (shown on FIG. 4) may be inserted into indentation 132 to pry open and remove top cover 102 from bottom cover 104. Top cover 102 may be removed to replace battery 130 and/or perform maintenance on other components (e.g., LED screen 124, LED lens 126, processor 112, and/or memory 114) within safety card 100.

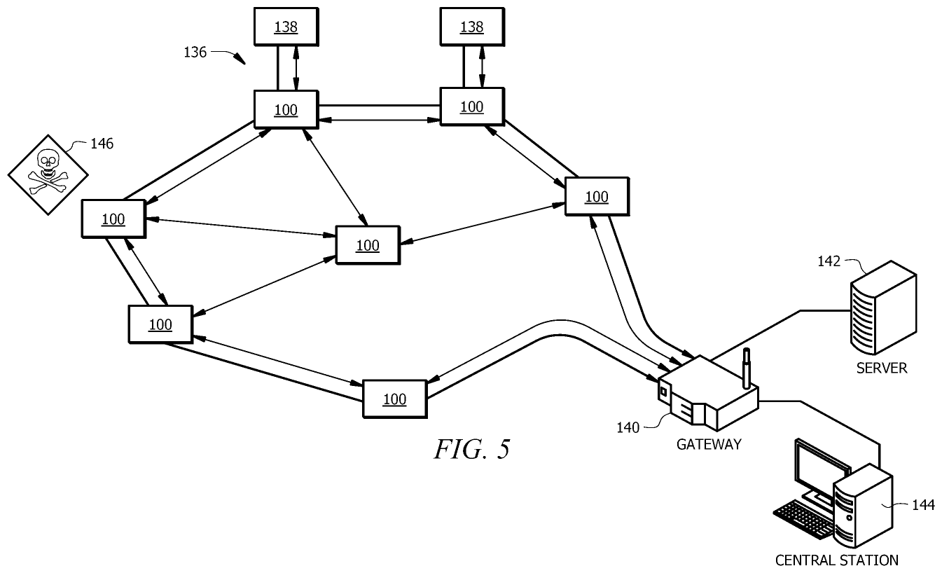

FIG. 5 is a schematic illustration of wireless mesh network 136 (e.g., 802.15.4 wireless mesh network, blue tooth) for use with safety cards 100. Wireless mesh network 136 may include a plurality of safety cards 100, at least one portable electronic device 138 (e.g., a smart phone), a gateway 140, server 142, and/or a central station 144. Wireless mesh network 136 may include a network topology in which each safety card 100 (mesh node) may relay data related to gas detection within wireless mesh network 136. Safety cards 100 may be connected via blue tooth to portable electronic devices 138. Safety cards 100 may cooperate with one another in order to distribute data throughout wireless mesh network 136. The safety cards 100 may act as a single mesh node within wireless mesh network 136. Wireless mesh network 136 may transmit data using a flooding technique (e.g., computer network routing algorithm in which every incoming packet is sent through every outgoing link except the one it arrived on), routing technique (e.g., selecting a path for traffic in a network, or between or across multiple networks), or combinations thereof.

With reference to FIGS. 1-5, operation of safety cards 100 may be described as follows. A user wearing a safety card 100 may access a secured area by utilizing NFC ID information. For example, the safety card 100 can be placed near a NFC reader, and the NFC reader may obtain an identification from the safety card 100. The reader can send the NFC ID information back to a central station and/or process the NFC ID directly to compare the NFC ID with an approved list of users. If the NFC ID matches an approved ID, the user may be granted access to an area. For example, a door may be unlocked, a gate may open, a barrier may be removed, or the like to allow the user to pass from one area to another (e.g., from their current position to a restricted area).

In addition to the access control features of the safety card 100, a toxic gas 146 (or a low gas level, such as, for example, an oxygen level) may be detected by at least one safety card 100. Data relating to gas detection may be communicated throughout wireless mesh network 136 and to other users/workers wearing safety cards 100. That is, data relating to gas detection may be communicated from at least one safety card 100 to the other safety cards 100, gateway 140, server 142 and central station 144. As noted above, data relating to gas detection may include an alarm. An alarm may be triggered when a detected gas concentration exceeds a predetermined threshold (or falls below a minimum threshold for a gas, such as, for example, oxygen). The alarm may be activated at one safety card 100 which detects the gas, and then the alarm may be transmitted (from the safety card 100 that first detected the gas) to all of the safety cards 100 and portable electronic devices 138 within wireless mesh network 136. The alarm may be viewed on display 110 of each safety card 100. Portable electronic devices 138 may also display the data relating to gas detection (e.g., the alarm). Upon receiving data relating to gas detection (e.g., an alarm), central station 144 may transmit an evacuation message throughout wireless mesh network 136. The evacuation message may be received by safety cards 100 and portable electronic devices 138. A security team may evacuate workers/users from the secured area, and clear toxic gas 146.

Having described various systems and methods, various embodiments can include, but are not limited to:

In a first embodiment, a safety card may comprise a gas detector, wherein the gas detector may comprise a sensing element configured to sense gas; and a wireless module coupled to the sensing element, wherein the wireless module is configured for an 802.15.4 wireless mesh network; wherein the safety card is configured to communicate over the 802.15.4 wireless mesh network with a plurality of other safety cards and a smart phone; and a near field communication identification module, wherein the near field communication identification module is configured to communicate with a near field communication reader and provide an identification of the safety card to the near field communication reader; wherein a height of the safety card is about 40 mm to about 60 mm; wherein a width of the safety card is about 60 mm to about 90 mm; wherein a thickness of the safety card is less than about 4 mm; wherein the safety card is configured to access a secured area.

A second embodiment can include the safety card of the first embodiment, wherein the sensing element is further configured to sense temperature, humidity, and noise.

A third embodiment can include the safety card of the first or second embodiments, wherein the safety card further comprises near field communication identification information for access control to secured areas.

A fourth embodiment can include the safety card of any of the first to third embodiments, wherein the safety card is configured to communicate data relating to gas detection.

A fifth embodiment can include the safety card of the fourth embodiment, wherein the data relating to gas detection comprises air quality, time, user location, gas detection history data, emergency information, alarms, gas exposure limits, gas concentration, and user identification information.

A sixth embodiment can include the safety card of any of the first to fifth embodiments, wherein the safety card is configured to access cloud storage and cloud services.

A seventh embodiment can include the safety card of any of the first to sixth embodiments, wherein the sensing element comprises a solid electro-chemical sensor.

An eighth embodiment can include the safety card of any of the first to seventh embodiments, wherein the solid electro-chemical sensor is printable.

In a ninth embodiment, a method for gas detection may comprise detecting a gas with a safety card, wherein the safety card comprises: a sensing element configured to sense gas; and a wireless module, wherein the wireless module is configured for an 802.15.4 wireless mesh network; wherein the safety card is configured to communicate over the 802.15.4 wireless mesh network with a plurality of safety cards; wherein a height of the safety card is about 40 mm to about 60 mm; wherein a width of the safety card is about 60 mm to about 90 mm; wherein a thickness of the safety card is less than about 4 mm; sensing that a concentration of the gas is above or below a predetermined threshold; activating an alarm based on the concentration of the gas; transmitting the alarm to the plurality of safety cards via the 802.15.4 wireless mesh network; transmitting a near field communication identification from the safety card to a near field communication reader in response to placing the safety card near the near field communication reader; and granting access to a restricted area in response to the near field communication identification matching an approved near field identification for the restricted area.

A tenth embodiment can include the method of the ninth embodiment, further comprising transmitting the alarm to a gateway, a server, and a central station.

An eleventh embodiment can include the method of the ninth or tenth embodiment, further comprising transmitting from the central station an evacuation message to the plurality of safety cards via the 802.15.4 wireless mesh network.

A twelfth embodiment can include the method of any of the ninth to eleventh embodiments, further comprising transmitting air quality, time, user location, emergency information, gas exposure limits, gas concentration, and user identification information.

A thirteenth embodiment can include the method of any of the ninth to twelfth embodiments, further comprising displaying the alarm on the plurality of safety cards.

A fourteenth embodiment can include the method of any of the ninth to thirteenth embodiments, further comprising sensing temperature, humidity and noise.

A fifteenth embodiment can include the method of any of the ninth to fourteenth embodiments, further comprising transmitting the alarm to a smart phone.

In a sixteenth embodiment, a system for gas detection comprising: a plurality of safety cards, wherein each safety card comprises: a sensing element configured to sense gas; and a wireless module, wherein the wireless module is configured for an 802.15.4 wireless mesh network; wherein the safety card is configured to communicate over the 802.15.4 wireless mesh network; wherein a height of the safety card is about 40 mm to about 60 mm; wherein a width of the safety card is about 60 mm to about 90 mm; wherein a thickness of the safety card is less than about 4 mm; a smart phone; a gateway; a server; and a central station; wherein the plurality of safety cards, the gateway, the server, and the central station are connected to the 802.15.4 wireless mesh network; wherein the plurality of safety cards are configured to access a secured area.

A seventeenth embodiment can include the system of the sixteenth embodiment, wherein the sensing element is further configured to sense temperature, humidity, and noise.

An eighteenth embodiment can include the system of the sixteenth or seventeenth embodiments, wherein the safety card is configured to communicate data relating to gas detection.

A nineteenth embodiment can include the system of any of the sixteenth to eighteenth embodiments, wherein the data relating to gas detection comprises air quality, time, user location, gas detection history data, emergency information, alarms, gas exposure limits, gas concentration, and user identification information.

A twentieth embodiment can include the system of any of the sixteenth to nineteenth embodiments, wherein each safety card further comprises near field communication identification information for access control to secured areas.

While various embodiments in accordance with the principles disclosed herein have been shown and described above, modifications thereof may be made by one skilled in the art without departing from the spirit and the teachings of the disclosure. The embodiments described herein are representative only and are not intended to be limiting. Many variations, combinations, and modifications are possible and are within the scope of the disclosure. Alternative embodiments that result from combining, integrating, and/or omitting features of the embodiment(s) are also within the scope of the disclosure. Accordingly, the scope of protection is not limited by the description set out above, but is defined by the claims which follow, that scope including all equivalents of the subject matter of the claims. Each and every claim is incorporated as further disclosure into the specification, and the claims are embodiment(s) of the present invention(s). Furthermore, any advantages and features described above may relate to specific embodiments, but shall not limit the application of such issued claims to processes and structures accomplishing any or all of the above advantages or having any or all of the above features.

Additionally, the section headings used herein are provided for consistency with the suggestions under 37 C.F.R. 1.77 or to otherwise provide organizational cues. These headings shall not limit or characterize the invention(s) set out in any claims that may issue from this disclosure. Specifically and by way of example, although the headings might refer to a “Field,” the claims should not be limited by the language chosen under this heading to describe the so-called field. Further, a description of a technology in the “Background” is not to be construed as an admission that certain technology is prior art to any invention(s) in this disclosure. Neither is the “Summary” to be considered as a limiting characterization of the invention(s) set forth in issued claims. Furthermore, any reference in this disclosure to “invention” in the singular should not be used to argue that there is only a single point of novelty in this disclosure. Multiple inventions may be set forth according to the limitations of the multiple claims issuing from this disclosure, and such claims accordingly define the invention(s), and their equivalents, that are protected thereby. In all instances, the scope of the claims shall be considered on their own merits in light of this disclosure, but should not be constrained by the headings set forth herein.

Use of broader terms such as “comprises,” “includes,” and “having” should be understood to provide support for narrower terms such as “consisting of,” “consisting essentially of,” and “comprised substantially of.” Use of the terms “optionally,” “may,” “might,” “possibly,” and the like with respect to any element of an embodiment means that the element is not required, or alternatively, the element is required, both alternatives being within the scope of the embodiment(s). Also, references to examples are merely provided for illustrative purposes, and are not intended to be exclusive.

While several embodiments have been provided in the present disclosure, it should be understood that the disclosed systems and methods may be embodied in many other specific forms without departing from the spirit or scope of the present disclosure. The present examples are to be considered as illustrative and not restrictive, and the intention is not to be limited to the details given herein. For example, the various elements or components may be combined or integrated in another system, or certain features may be omitted or not implemented.

Also, techniques, systems, subsystems, and methods described and illustrated in the various embodiments as discrete or separate may be combined or integrated with other systems, modules, techniques, or methods without departing from the scope of the present disclosure. Other items shown or discussed as directly coupled or communicating with each other may be indirectly coupled or communicating through some interface, device, or intermediate component, whether electrically, mechanically, or otherwise. Other examples of changes, substitutions, and alterations are ascertainable by one skilled in the art and could be made without departing from the spirit and scope disclosed herein.

What is claimed is:

1. A safety card (100) comprising:
a gas detector, wherein the gas detector comprises:
a sensing element (106) configured to sense gas; and
a wireless module (108) coupled to the sensing element (106), wherein the wireless module (108) is configured for an 802.15.4 wireless mesh network;
wherein the safety card (100) is configured to communicate over the 802.15.4 wireless mesh network (136) with a plurality of other safety cards (100) and a smart phone (138); and
a near field communication identification module (109), wherein the near field communication identification module (109) is configured to communicate with a near field communication reader and provide an identification of the safety card (100) to the near field communication reader;
wherein a height of the safety card (100) is about 40 mm to about 60 mm;
wherein a width of the safety card (100) is about 60 mm to about 90 mm;
wherein a thickness of the safety card (100) is less than about 4 mm;
wherein the safety card is configured to access a secured area.

2. The safety card (100) of claim 1, wherein the sensing element (106) is further configured to sense temperature, humidity, and noise.

3. The safety card (100) of claim 1, wherein the safety card (100) further comprises near field communication identification information for access control to secured areas.

4. The safety card (100) of claim 1, wherein the safety card (100) is configured to communicate data relating to gas detection.

5. The safety card (100) of claim 4, wherein the data relating to gas detection comprises air quality, time, user location, gas detection history data, emergency information, alarms, gas exposure limits, gas concentration, and user identification information.

6. The safety card (100) of claim 1, wherein the safety card (100) is configured to access cloud storage and cloud services.

7. The safety card (100) of claim 1, wherein the sensing element (106) comprises a solid electro-chemical sensor.

8. The safety card (100) of claim 7, wherein the solid electro-chemical sensor is printable.

9. A method for gas detection comprising:
detecting a gas with a safety card (100), wherein the safety card (100) comprises:
a sensing element (106) configured to sense gas; and
a wireless module (108), wherein the wireless module (108) is configured for an 802.15.4 wireless mesh network (136);
wherein the safety card (100) is configured to communicate over the 802.15.4 wireless mesh network (136) with a plurality of safety cards (100);
wherein a height of the safety card (100) is about 40 mm to about 60 mm;
wherein a width of the safety card (100) is about 60 mm to about 90 mm;
wherein a thickness of the safety card (100) is less than about 4 mm;
sensing that a concentration of the gas is above or below a predetermined threshold;
activating an alarm based on the concentration of the gas; and
transmitting the alarm to the plurality of safety cards (100) via the 802.15.4 wireless mesh network (136);
transmitting a near field communication identification from the safety card (100) to a near field communication reader in response to placing the safety card (100) near the near field communication reader; and
granting access to a restricted area in response to the near field communication identification matching an approved near field identification for the restricted area.

10. The method of claim 9, further comprising transmitting the alarm to a gateway (140), a server (142), and a central station (144).

11. The method of claim 10, further comprising transmitting from the central station (144) an evacuation message to the plurality of safety cards (100) via the 802.15.4 wireless mesh network (136).

12. The method of claim 9, further comprising transmitting air quality, time, user location, emergency information, gas exposure limits, gas concentration, and user identification information.

13. The method of claim 9, further comprising displaying the alarm on the plurality of safety cards (100).

14. The method of claim 9, further comprising sensing temperature, humidity and noise.

15. The method of claim 9, further comprising transmitting the alarm to a smart phone (138).
